(19) United States
(12) Patent Application Publication
(10) Pub. No.: US 2025/0383711 A1
(43) Pub. Date: Dec. 18, 2025

(54) LIGHTWEIGHT GLOVE-FREE HAPTIC DEVICE FOR PRECISION MANIPULATION TASKS IN AUGMENTED AND VIRTUAL REALITY

(71) Applicant: Georgia Tech Research Corporation, Atlanta, GA (US)

(72) Inventor: Alexis Noel, Atlanta, GA (US)

(21) Appl. No.: 18/743,492

(22) Filed: Jun. 14, 2024

(51) Int. Cl. G06F 3/01; G06F 3/0346; G09B 5/02

(52) U.S. Cl. CPC G06F 3/014; G06F 3/016; G06F 3/0346; G09B 5/02

(57) ABSTRACT

An exemplary embodiment of the present disclosure provides a haptic sensing device. The sensing device can comprise a plurality of finger sensors, and a controller. The controller can be in communication with the plurality of finger sensors. The controller can be configured to receive sensor data signals from the plurality of finger sensors and, based at least in part on the received sensor data signals, track a movement of fingers of a user in an extended reality environment.

### FIELD OF THE DISCLOSURE

The various embodiments of the present disclosure relate generally to haptic devices for extended reality environments.

### BACKGROUND

Virtual reality (VR) is transforming the way we think about training the next-generation workforce. Current training methodologies rely upon expert-to-novice communication, which can often be expensive and unstructured, leading to knowledge lost in transition. VR training simulations can provide novices a means of practicing basic skills and emergency scenarios, enhancing memory retention through repetition. Many services are starting to use VR for training, from F-35 and helicopter cockpit simulations to aircraft maintenance, to nuclear power plant training on standard operating procedures. However, VR fall short when it comes to simulating touch; reliance on point-and-click controllers do not help build muscle memory most often needed in technical fields.

Traditional VR controllers are excellent interactors for virtual trigger-based objects (guns, pointers, etc.), yet they fall short in terms of precision-based selections and interaction with small objects, such as switches on a control panel. For users new to VR technology, operating the controllers can also have a steep learning curve, leading to higher cognitive load and reduced performance in the VR simulation. An ideal VR simulation would involve intuitive finger-based grabbing, pointing, and manipulation; this capability can require finger tracking (mapping real-world finger movement to the virtual space) and haptic feedback to affirm virtual object contact. Haptic feedback is the sensation of “touch” in a virtual environment through fingertip forces or vibratory sensation.

A number of companies have built controller-free haptic glove systems, i.e., systems not employing joysticks, buttons, and other actuation devices but rather tracking hand movement for input to a VR environment; while these systems provide haptic feedback, they suffer from lack of precision finger tracking. Their finger tracking methods rely on inaccurate sensors, such as flex sensors or tension-based string mechanisms. Lack of accurate finger tracking results in virtual fingers not matching real-world finger movement; the haptic feedback provided then does not match to the virtual object interaction, breaking simulation immersion. Additionally, these gloves are bulky and heavy, leading to arm and hand fatigue.

Researchers have investigated how to provide accurate finger tracking, using magnetics, bend or strain sensors, inertial/compass-based tracking (IMU's), and vision-based tracking. Magnetic-based sensored gloves, while highly accurate and quick to respond, are disturbed by magnetic fields and cannot be in proximity to metal. Bend or strain sensors are inexpensive but suffer from slow responsiveness and accuracy degradation over time. IMU-based gloves work well for tracking orientation but have difficulty in tracking translation due to stacking drift when using the accelerometer. The VIST framework glove uses IMUs on each finger joint, in addition to a head-mounted stereo camera; this design has accurate finger tracking, but requires a separate bulky camera, and a full glove for tracking markers. The biggest drawback of vision-only tracking, such as the Meta Quest hand tracking module, is occlusion; occlusion is where the cameras on the headset “lose sight” of the hand and cannot predict location.

Accordingly, there is a need for improved haptic sensing devices and methods that overcome one or more of the disadvantages discussed above.

### BRIEF SUMMARY

An exemplary embodiment of the present disclosure provides a haptic sensing device. The sensing device can comprise a plurality of finger sensors, and a controller. The controller can be in communication with the plurality of finger sensors. The controller can be configured to receive sensor data signals from the plurality of finger sensors and, based at least in part on the received sensor data signals, track a movement of fingers of a user in an extended reality environment.

In any of the embodiments disclosed herein, each of the plurality of finger sensors can comprise at least one inertial measurement unit (IMU), and the sensor data signals can comprise IMU data.

In any of the embodiments disclosed herein, each of the IMUs can comprise an accelerometer, a magnetometer, and a gyroscope.

In any of the embodiments disclosed herein, the controller can be configured to receive visual data and determine whether the visual data is indicative of a visual representation of a predetermined portion of the fingers of a user. The controller can be further configured such that if the controller determines the visual data is indicative of a visual representation of the predetermined portion of the fingers of a user, and the controller can be further configured to track a movement of fingers of a user in the extended reality environment based, at least in part, on the visual data.

In any of the embodiments disclosed herein, the controller can be further configured such that if the controller determines the visual data is not indicative of a visual representation of the predetermined portion of the fingers of a user, the controller can be configured to track a movement of fingers of a user in the extended reality environment based, at least in part, on the IMU data.

In any of the embodiments disclosed herein, each of the plurality of finger sensors can be disposed on a finger cap configured to secure the sensor proximate a distal end of a finger of the user, and the finger cap can be configured to exert a compressive force on the corresponding distal end of the finger.

In any of the embodiments disclosed herein, each finger cap can comprise an elastomer material.

In any of the embodiments disclosed herein, each finger cap can comprise an opening configured to expose at least a portion of a finger pad of the corresponding finger.

In any of the embodiments disclosed herein, the controller can comprise a wrist portion configured to be removably attached the user proximate the user's wrist.

In any of the embodiments disclosed herein, each of the plurality of finger sensors can be electrically coupled to at least a portion of the controller via one or more wires, and the one or more wires can have a length ranging from eight to 14 inches.

In any of the embodiments disclosed herein, each of the plurality of finger sensors can further comprise a haptic feedback actuator configured to provide physical haptic feedback to the fingers of a user.

In any of the embodiments disclosed herein, the haptic feedback actuator can be selected from the group consisting of a vibration motor, a hydraulically amplifies self-healing electrostatic (HAZEL) actuator, an electroosmotic pump array, a piezoelectric actuator, and a microhydraulic actuator.

Another embodiment of the present disclosure provides a method of tracking hand movement of a user in an extended reality environment. The method can comprise: receiving sensor data signals from a plurality of finger sensors, each finger sensor positioned on a finger of the user; receiving visual data; determining whether the visual data is indicative of an image of a predetermined portion of the user's fingers; if the visual data is indicative of an image of the predetermined portion of the user's fingers, tracking, based at least in part on the visual data, a movement of fingers of a user in an extended reality environment; and if the visual data is not indicative of an image of the predetermined portion of the user's fingers, tracking, based at least in part on the sensor data signals, a movement of fingers of a user in the extended reality environment.

Another embodiment of the present disclosure provides a haptic sensing device, comprising: a plurality of finger sensors and a controller. Each finger sensor can comprise an inertial measurement unit (IMU). The controller can be in communication with the plurality of finger sensors. The controller can be configured to receive sensor data signals comprising IMU data from the plurality of finger sensors and visual data. The controller can be further configured to determine whether the visual data is indicative of an image of a predetermined portion of a user's fingers. If the visual data is indicative of an image of a predetermined portion of a user's fingers, the controller can be configured to track, based at least in part on the visual data, a movement of fingers of a user in an extended reality environment. If the visual data is not indicative of an image of a predetermined portion of a user's fingers, the controller can be configured to track, based at least in part on the sensor data signals, a movement of fingers of a user in the extended reality environment.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIGS. 1A-D provide perspective views of a haptic sensing device, in accordance with some embodiments of the present disclosure.

FIG. 2 provides a signal and data flow diagram, in accordance with some embodiments of the present disclosure.

FIG. 3 provides a flow chart of a method of haptic sensing, in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Some embodiments of the present disclosure provide controller-free (i.e., no joystick, button, or other device requiring actuation by the user) haptic systems that can increase immersivity in extended reality training environments through sensor fusion. As used herein, the term extended reality encompasses VR, augmented reality (AR), and mixed reality (MR). The haptic systems disclosed herein can allow trainees to interface with common objects in XR (buttons, switches, screens) with intuitive and immersive tactile feedback on the fingertips. These haptic systems are uniquely situated to provide high precision finger tracking in XR through the assimilation of hand tracking using machine vision on existing VR headsets, such as the Oculus Quest 3 VR headset, and high degree-of-freedom orientation sensors on each fingertip. The systems disclosed herein can be lightweight, cable-free, and form fitting to any hand size, making it rapidly deployable for mobile training environments.

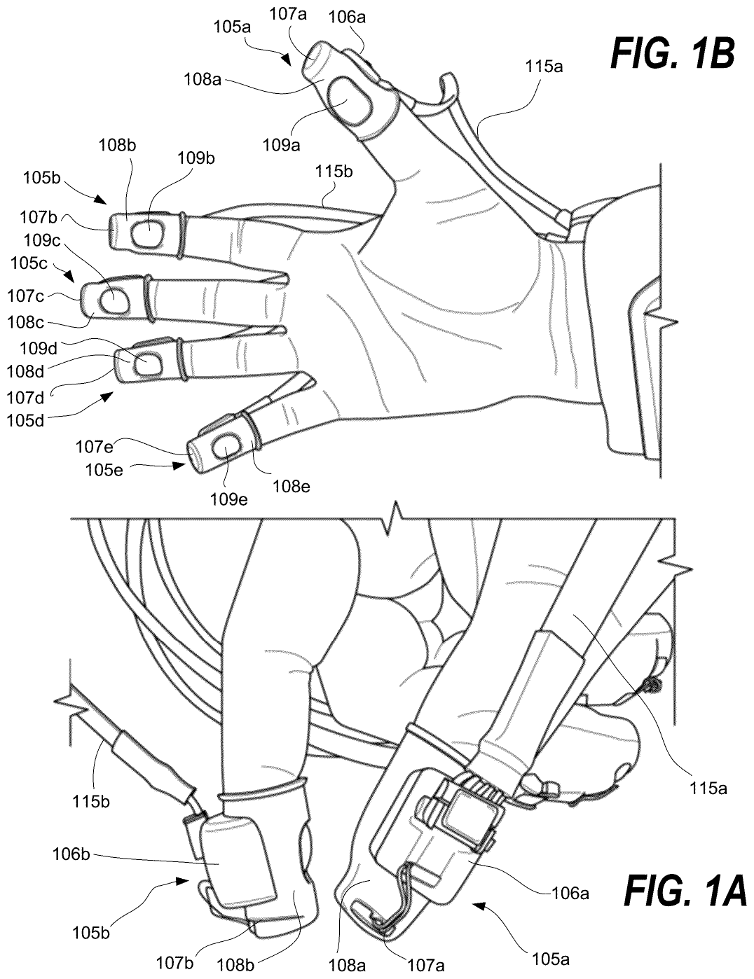

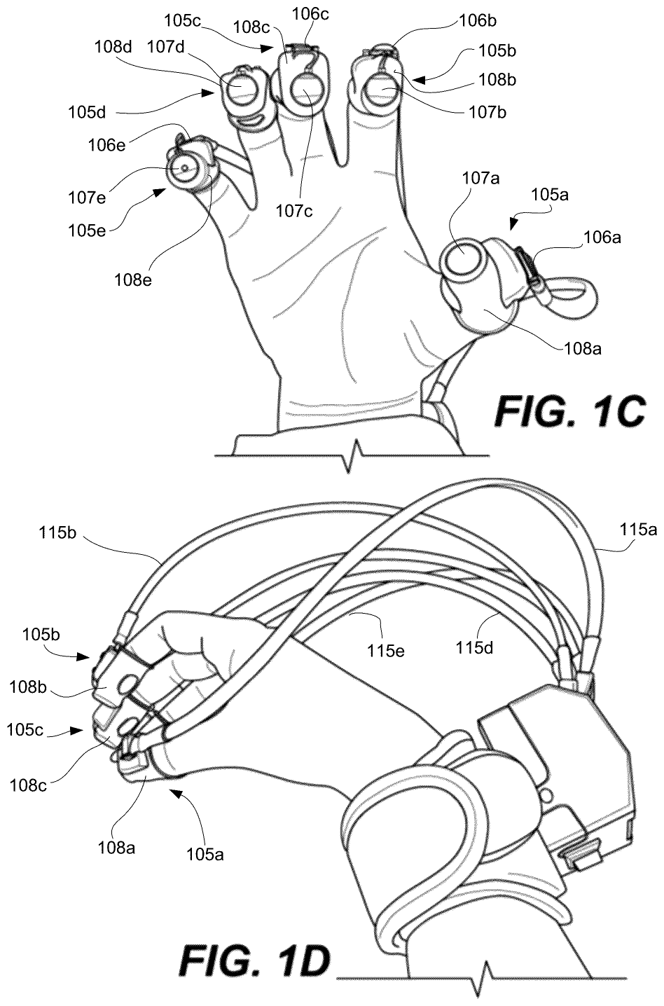

As shown in FIGS. 1A-D, an exemplary embodiment of the present disclosure provides a haptic sensing device. The sensing device can comprise a plurality of finger sensors 105a-e, and a controller 110. The controller can be in communication with the plurality of finger sensors 105a-e, such that the controller 110 can receive sensor data signals from the plurality of finger sensors 105a-e. As shown in FIGS. 1A-D, the controller 110 can be connected to the finger sensors 105a-e by wires 115a-e. In some embodiments, however, the finger sensors 105a-e can be in wireless communication with the controller 110.

In embodiments where the sensors 105a-e are connected to the controller 110, the wires 115a-e can be at a length as to not inhibit movement of the user's fingers. For example, in some embodiments, the wires 115a-e can have a length of at least 8 inches, at least 10 inches, or at least 12 inches. In some embodiments, the wires 115a-e can have a length up to 10, 12, 14, or 16 inches. This can assist with haptic feedback by making the user feel as though the user is not wearing the sensing system.

The controller 110 can be many different controllers known in the art, including, but no limited to, microcontrollers, central processing units, smart phones, tablets, and the like. In some embodiments, the controller 110 can comprise multiple subcontrollers that operate together to perform the various functions disclosed herein. For example, in some embodiments, the controller 110 can include a local portion that is wired to the fingers and a remote portion that is in wireless or wired communication with the local portion. As shown in FIGS. 1A-D, in some embodiments, the controller 110, or a portion of the controller 110 can be removably attached to the user via a wrist strap 111. In other embodiments, however, the controller 110 can be attached to the user at other locations (e.g., arm, torso, etc.) or via other means (e.g., compressive sleeve). The controller can include one or more processors (operating independently or collectively) and one or more memories storing instructions for carrying out the various functions disclosed herein.

The finger sensors 105a-e can be many different sensors known in the art. In some embodiments, the sensors 105a-e can comprise one or more inertial measurement units (IMUs) 106a-e, and the sensor data signals can comprise IMU data. Each IMU 106a-e can include one or more of an accelerometer, a magnetometer, and a gyroscope, thus providing data at up to nine degrees of freedom.

As shown in FIGS. 1A-D, each of the finger sensors 105a-e can be disposed on a finger cap 108a-e configured to secure the sensor 105a-e proximate a distal end of a finger of the user. In some embodiments, the finger cap 108a-e can be configured to exert a compressive force on the corresponding distal end of the finger. For example, the finger cap 108a-e can comprise an elastomer material, such as silicone, surrounding at least a portion of the distal end of the finger.

As discussed above, one disadvantage with convention haptic sensing systems is a reduction in tactile feedback to the user due to covering the entirety of the fingers/hands. Accordingly, in some embodiments of the present disclosure, each finger cap 108a-e can comprise an opening 109a-e configured to expose at least a portion of a finger pad of the corresponding finger. This can allow the user to move the hand and touch objects (including other fingers) without feeling as though the user is wearing the device.

In some embodiments, the finger sensors 105a-e can comprise one or more haptic feedback actuators 107a-e configured to provide physical haptic feedback to the fingers of a user. The haptic feedback actuators 107a-e can be many different actuators known in the art, including, but not limited to, vibration motors, hydraulically amplifies self-healing electrostatic (HAZEL) actuators, electroosmotic pump arrays, piezoelectric actuators, microhydraulic actuators, and the like.

As discussed above, the controller 110 can receive sensor data signals from the finger sensors 105a-e. Based at least in part on the received sensor data signals, the controller 110 can track a movement of fingers of a user in an extended reality environment.

As also discussed above, as those skilled in the art would appreciate, certain conventional XR systems track movement of a user's hands through the use of visual data collected from cameras. In some embodiments of the present disclosure, the controller 110 can use such visual data in combination with finger sensor data (e.g., IMU data) to track movement of fingers in the XR environment. For example, in some embodiments, the controller 110 can receive visual data and determine whether the visual data is indicative of a visual representation of a predetermined portion of the fingers of a user (e.g., certain joints). If the controller 110 determines the visual data is indicative of a visual representation of the predetermined portion of the fingers of a user, the controller 110 can track a movement of fingers of a user in the extended reality environment based, at least in part, on the visual data. If, however, the controller 110 determines the visual data is not indicative of a visual representation of the predetermined portion of the fingers of a user (e.g., instances where an occlusion is determined), the controller 110 can track a movement of fingers of a user in the extended reality environment based, at least in part, on the IMU data. This allows the controller 110 to use visual data when it is available but pivot to IMU data (or a combination of visual and IMU data) otherwise.

Below certain exemplary implementations are described and characterized. These examples are for explanatory purposes only and should not be construed as limited the scope of the claims appended hereto. The embodiments disclosed above can also implement one or more of the features of the exemplary systems disclosed below.

### EXAMPLES

Disclosed below is a lightweight, cable-free, controller-free system for providing haptic feedback on fingertips in VR. The haptic device is referred to as LiGHT-VR, an acronym for lightweight Glove-free Haptics for Training in Virtual Reality. The approach is unique, integrating 9-degree-of-freedom (DOF) IMU sensors with the experimental hand-tracking feature of the Oculus Quest 3 in a glove-free design. This method provides an inexpensive, lightweight solution to finger tracking, without the issues of hand-size incompatibility of a glove.

### Hardware Design

The LiGHT-VR device comprises three subsystems: the finger caps, the cables, and the wrist box. The device total weight is 185 g (0.4 lb.) for each hand. The wrist box is secured to the forearm with a Velcro-based strap. FIGS. 1A-D illustrate various design decisions to minimize contact between device and hand; In FIG. 1A, silicone thickness at the fingertips is minimized to reduce immersion-breaking proprioception disconnect during a pinching motion. In FIG. 1B, the smallest available vibration motors are secured to the fingertips to provide haptic feedback. In FIG. 1C, cut-outs of the silicone on the finger pads retain pad-to-pad pinching feedback. In FIG. 1D, the connecting cables are set at 12″ long, enough clearance to ensure no cable-skin contact during maximum wrist and finger bend positions.

### Finger Cap Subsystem Details

Each finger of the finger cap subsystem comprises a custom-cast silicone cap, the finger board, and a vibration motor. The finger board houses a Bosch BNO085 9-degree of freedom Inertial Measurement Unit (IMU). The BNO085 provides rotational data through a combination of three sensors: an accelerometer, a gyrometer, and a magnetometer. The data is sent from the finger board to the wrist board via two I2C communication lines (TX/RX). Six wires connect each finger board to the wrist board. The vibration motor is a 3.3V DC motor, which is powered through a PWM signal line from the wrist board. The silicone caps come in three sizes, with the large diameter cap for the thumb, small diameter cap for the pinky, and medium diameter cap for all other fingers.

### Cable Subsystem Details

The cable is a Molex Micro-Lock PLUS snap based connector with six wires, which has a 1.25 mm pitch and a snapping action to ensure a strong connection between cable and finger board and wrist board. A qualitative assessment was performed to understand what wearable device features would cause occlusion (i.e., camera blocking) with the cameras used for the machine vision hand tracking. The color black caused occlusion while colored or tan wires and tape did not. Therefore, the cable wrap was chosen to have a non-black color.

### Wrist Box Subsystem Details

The wrist box houses the wrist board, the microcontroller (Arduino Nano 33 IoT), the 2S LiPo battery, and the associated electronic components for cabling and connections. The wrist box further comprises a battery monitor. The LiGHT-VR device can operate for approximately 1 hour and 30 minutes with the current battery size and current draw. The wrist board routes communication and power lines between the Arduino, battery, and finger board. A multiplexer is used to split the I2C signals and minimize wrist board size.

### Signal and Data Pipeline

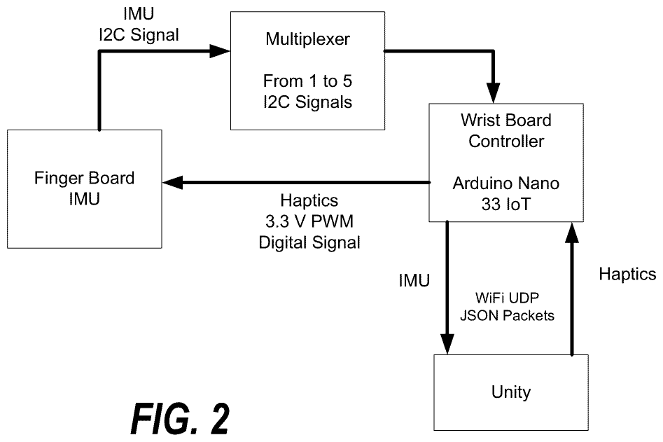

FIG. 2 details the signal and data pipeline, from the finger board, to wrist board, to Unity, and vice versa. The system was designed for low latency data streaming over a cellular network; UDP data packets have a roundtrip time of 20 ms, assuming a strong cellular signal. UDP communication is used to send the data collected by the Arduino to any desired device on the same network. Once the glove is connected to the network, it awaits a packet from the client device. Once this is received, the IP of that device becomes the target for all future packets. All data from the IMUs are then compiled into a JSON and are sent back to the client to be unpacked and used in the desired application.

As IMU data is sent to the client device, the glove also receives packets back for various purposes. Packets containing binary strings can be sent by the client representing haptics for each finger. Additionally, commands can be sent to remotely trigger the tare and calibration procedures. This is used in Unity to automatically issue these commands when the user's hands are in a stable position in order to mitigate inaccuracies due to drift.

An external debugger (or, packet sniffer) was developed in order to identify packets being exchanged between the LiGHT-VR device and Unity, without having to plug in the device to a computer. The debugger is a Python script utilizing Scapy, a package that enables packet sniffing, to scan the network for UDP packets from two specified IP addresses and ports. When the program is launched, a TKinter GUI is started that prompts the user for these IPs and ports. After this, it constantly updates to show the most recent packet sent by each device. Along with showing the most recent packet, the debugger is also capable of visualizing the JSON messages in each packet. It does this using a MatPlotLib 3D graph to display a vector representing each quaternion in the message.

### Sensor Fusion

To precisely track finger location, the LiGHT-VR device uses 9 degree-of-freedom (DOF) IMU sensors in addition to the novel hand tracking algorithm found in inside-out VR headsets to track fingertip and joint positions.

Fingertip translation is measured using Meta's experimental hand-tracking algorithm for the Quest 3 VR platform. The hand-tracking feature uses the VR headset's forward-facing cameras with a machine learning algorithm to locate hand knuckles and overall hand shape. Each detected joint is assigned an interaction collider, which places a virtual bubble around the detected zone; this bubble drives when contact occurs. While the vision-based hand tracking can track both translation and orientation, the biggest drawback is occlusion.

Fingertip orientation is measured using the Bosch BNO085 IMU, is a high precision orientation sensor. The BNO085 integrates a triaxial 14-bit accelerometer, a triaxial 16-bit gyroscope with a range of ±2000 degrees per second, a triaxial geomagnetic sensor and a 32-bit cortex M0±microcontroller running CEVA SH-2 sensor fusion software. The BNO085 is equipped with a digital bi-directional I2C interface. The sensor interprets these three sets of orientation data, and can provide the following in either Euler vectors or quaternions: absolute orientation, angular velocity, acceleration, magnetic field strength, linear acceleration, and gravity.

Sensor data from the IMUs is processed onboard the Arduino using the Arduino IDE language, a variant of the C++programming language. The VR environment is developed in the game engine Unity, with the scripting in C#. The data is sent from the IMU to Unity via the wireless microprocessor Arduino Nano 33 IoT. The board's main process is a low power Arm Cortex-M0 32-bit SAMD21. WiFi connectivity is performed with the NINA-W10, a low power chipset operating in the 2.4 GHz range, with secure communication ensured through the Microchip ECC608 crypto chip.

The hand tracking feature sans IMU data is surprisingly effective at tracking fingertips during button pushing and key pressing in XR. The scale for technical training needs in a button and switch virtual exercise enabled the team to simplify the sensor fusion algorithm to an occlusion-based binary system. If the machine vision cameras lose track of the hands, the VR hand model will switch from using machine vision data to using solely IMU data. If occlusion happens for an extended period of time, the user will get notified that the fingers may not be tracking with precision anymore (an empirically measured maximum drift time t_{drift}). A more detailed discussion on this algorithm is provided below on confidence determination.

### Inertial Measurement Unit (IMU) Characterization

One of the core components of the LiGHT-VR system was the BNO085 IMU. As stated previously, it enables the LiGHT-VR glove to collect information regarding the movement of our glove from acceleration, rotational velocity, orientation, quaternions and much more. These readings would then be combined with the machine vision hand tracking to create an immersive and extremely accurate experience and tracking system. Unfortunately, IMUs suffer from a buildup in error (known as drift) due to an accumulation of measurement errors from integration of a noisy output signal over time. The BNO085 IMU utilized in the LiGHT-VR device is no different. As a result, an essential area of the project was to characterize and correct these drifts in order to provide the most accurate and ideal readings from the glove for its use cases. Additionally, a goal was to determine how long the IMU data can be trusted, before needing to “re-initialize” the fingertips with the machine vision. The LiGHT-VR device uses rotation vector quaternions; therefore, the following subsections place most emphasis on discussion the accuracy and drift present in those readings.

### Types of IMU Rotation Vectors from the BNO085

A factor that goes into the IMU characterization process is deciding what rotation vectors will be tested and what each type of rotation vector describes. All rotation vectors in the context of the BNO085 are described as a simple orientation descriptor calculated and provided as a quaternion in the format real, i, j, k from its library. Overall, the BNO085 supplies approximately 6 different types of rotation vectors with each one having its own unique properties and use cases. Each type also has its own degree of freedom of 6-axis or 9-axis where a 6-axis indicates a quaternion that utilizes only the accelerometer and gyroscope while a 9-axis adds the magnetometer. For the LiGHT-VR device specifically, only 4 of the BNO085′s supplied quaternions were tested and analyzed in terms of drift. These are the Rotation Vector, Game Rotation Vector, AR/VR Stabilized Game Rotation Vector and Gyro-Integrated Rotation Vector. The Game Rotation Vectors were most applicable to the LiGHT-VR device due to their specialty in game or VR applications while the basic Rotation Vector was important to compare to it. The remaining rotation vector types provided by the BNO085 were either irrelevant to the context of the project or could already be tested through another rotation vector.

Rotation Vector: The regular rotation vector simply titled Rotation Vector is the most accurate quaternion reading relative to the real physical world. It is a 9-axis reading meaning it uses all three of the core sensors on the IMU. Unlike other rotation vectors, the base Rotation Vector uses multiple real-world such both as magnetic north and gravity to provide its readings. As a result, each quaternion reading is roughly the same if the IMU is oriented and positioned in the same manner. For this reason, the basic Rotation Vector readings are also able to perform a form of self-calibration based on detecting where the magnetic north is to correct its yaw rotation and gravity for its roll and pitch. Although the basic Rotation Vector reading is stated to not be directly made for VR applications, it was important to compare these values to the other types of rotation vectors to visualize how they each relate to each other and how drift compares between them.

Game Rotation Vector: The Game Rotation Vector or GRV is an alternate kind of rotation vector that is 6-axis and so only uses the accelerometer and the gyroscope. The measurement still provides quaternion readings as expected but since it is 6-axis, it can only base its readings off on gravity as a reference. As a result, those quaternions provided will always start at the identity quaternion as long as the IMU is sitting at rest on a flat surface. Another effect of this is that without any magnetometer to detect yaw orientation, the quaternion value related to that, “k”, will begin to significantly drift overtime. Overall, the basic GRV was designed for applications in gaming due to the magnetometer potentially causing sudden jumps in readings, hence the name.

AR/VR Stabilized Game Rotation Vector: The AR/VR Stabilized Game Rotation Vector is simply a modification of the base Game Rotation Vector. It has all the same functionality and properties as the base GRV but also neglects the accelerometer in drift prevention for the same reason that sudden jumps in quaternion can cause issues in game applications.

Gyro-Integrated Rotation Vector: The final reading type tested was the Gyro-Integrated Rotation Vector or GIRV. The GIRV is a special type of rotation vector in that it can be individually configured to be based on the 6-axis GRV or the 9-axis basic Rotation Vector using the BNO085′s flash memory system. The GIRV quaternions can additionally be modified to enable quaternion prediction to generate readings dozens of milliseconds in advance. The GIRV quaternion readings exist to provide a method of obtaining quick sequential quaternion readings with its ability to predict future quaternions for applications that require such.

The best types of rotation vectors to use for the LiGHT-VR device were all the game rotation vector typed ones with the regular rotation vector only being tested to check whether it would be possible or not.

### Drift Testing Methodology

In order to test and measure how each rotation vector quaternion drifts over time, each test was conducted with the same methodology for consistency. Due to the main rotation vectors being tested being based on Game Rotation Vectors, the tests were created to match those characteristics. Below is a brief description of each step in the core testing Methodology:
1) Hold IMU flat and align it to a marked flat surface for 15 seconds. This ensures the initial quaternions are read and that the IMU can return to that same spot.
2) Raise the IMU and start moving or shaking it, ideally like how it would on the glove in a real setting. Do motions for 1 minute. Large movements are important since most drift occurs during them.
3) Repeat steps 1, aligning it to the same exact mark and positioning. This is essential to see how initial readings have changed after each movement session.
4) Repeat steps 1 to 3 until hitting a desired time like 5 minutes. Repeating is necessary to analyze how drift exists over a larger time frame.
5) Calculate the drift from each flat rest period during the IMU. Calculation can be done by comparing each flat rest time session and checking for quaternions that deviate from the initial quaternions.

There were an additional set of tests conducted to determine how the IMU would also react to no movement or smooth movements as well. Those tests were all performed on the same set of rotation vector quaternion readings mentioned above using the same testing methodology with the exception of step 2. In the no movement tests, the IMU was simply placed at rest for 10 minutes. In the smooth movement tests, the IMU was moved smoothly rather than quick, shaking movements and there were no in between stages. In total, there were three tests for each rotation vector type analyzed, heavy movement, smooth movement and no movement tests. Each test and its quaternion readings were placed into a CSV file using Python and eventually plotted for comparison in Python as well using matplotlib.

Throughout testing, since the main focus was on those quaternion readings based on the Game Rotation Vector, each rotation vector type tested was also compared to a basic Game Rotation Vector of the same exact motions, with exception to the regular Rotation Vector. Gyro-Integrated Rotation Vectors were also compared at different prediction values to analyze how effective or different prediction would be. This initial stage of testing was important to visualize just how different each rotation vector quaternion reading may actually be in practice compared to each other.

The first tests were to compare AR/VR Stabilized GRV to regular GRV. The ARVR Stabilized GRV are essentially the same. Even just analyzing the start and end to compare drift, both the ARVR Stabilized GRV and regular GRV have similar drift amounts as well for the k component. The only apparent difference between the two is that the ARVR Stabilized GRV seems to have ever so slightly smoother or less jagged peaks which is only present in certain areas. The reason for this could be due to the reasons stated before in that the ARVR Stabilized GRV is modified to reduce the amount of jumping due to corrections caused by the accelerometer or gyroscope. Notably, when looking at the drift, the more movement that the IMU faces, the more the drift becomes apparent. It was seen that when the IMU is completely at rest, no drift occurs at all in the given time frame, further supporting the idea that the Game Rotation Vector type quaternions face significant drift only during heavy movement.

The next sets of tests were done to test Gyro-Integrated Rotation Vector (GIRV) compared to base Game Rotation Vectors. There were two sets of these tests, one where the GIRV was given a prediction amount of 60 ms and one where it was only 28 ms.

Looking at Gyro-Integrated Rotation Vectors, it is evident that the readings are also extremely similar to the base Game Rotation Vector. The reason for this is most likely because the GIRV readings were configured to be based directly on the Game Rotation Vector itself much like the AR/VR Stabilized Game Rotation Vectors, meaning in most conditions, it should be identical. The only possible difference would be caused by the configured prediction which this case interestingly caused no major differences. Even during heavy movement sections, a larger prediction of 60 ms into the future still seemed to make little difference compared to its base Game Rotation Vector reading. What seems to be consistent with GIRV readings and the previous AR/VR tests is that the k quaternion reading continues to drift.

The final sets of tests were conducted to analyze how the regular basic Rotation Vectors read or drift compared to all of the Game Rotation Vector versions.

All in all, it can be concluded that between all the quaternion readings based on the Game Rotation Vector type, the differences are extremely minor meaning it might not matter directly which one to use. What does seem to matter is 9-axis vs. 6-axis since the regular Rotation Vector almost never starts at an identity quaternion and the 9-axis type are extremely jarring. These results further support the idea that Game Rotation Vectors and its iterations are the best for the LiGHT-VR device.

### IMU Drift Results

After each rotation vector type was tested and read over the given time frames, the next process was to determine the amount of quaternion drift within each. This process was fairly simple due to the method of reading the quaternions in the previous sub section. Each rotation vector reading type had resting periods where the IMU was physically placed and oriented back to its start, meaning drift could be measured by comparing those quaternions to the start.

In every single Game Rotation Vector based quaternion reading, the k component of that quaternion drifts significantly overtimes with increasing drift the longer a tare has not occurred. The i and j components occasionally drift by a value of around 0.01 but typically go no further than that. As stated previously, this is partially expected due to how anything based on the Game Rotation Vector is 6-axis and will not have a magnetometer to correct any drift in yaw rotation. Subsequently, the i and j drift would be minimal because there would be that accelerometer and gyroscope correcting those errors. The only anomaly was when after 138 seconds into the test, the i drift suddenly jumps to 0.05 before going back down to the correct quaternion in the next rest period.

For the regular Rotation Vector based quaternion readings, the drift was as stated, extremely inconsistent. Components like i and j of the quaternion remain fairly consistent, but the real and k components deviate significantly from the initial reading, even when physically the same.

Combining data from all of these tests, the final drift values to be concluded for Game Rotation Vector based quaternions are as follows: real Quaternion Drift=0.00 per 5 minutes of heavy movement; i Quaternion Drift=±0.01 per 5 minutes of heavy movement; j Quaternion Drift=±0.01 per 5 minutes of heavy movement; and k Quaternion Drift=−0.08 per 5 minutes of heavy movement.

For a better idea of what the results would actually mean, the quaternion drift values were converted into Euler Angles where each drift value represented an offset from the identity quaternion or a base 0-degree Euler Angle. Here are the results in that format: Yaw Drift=−0.1595° per 5 minutes of heavy movement; Pitch Drift=±0.0215° per 5 minutes of heavy movement; and Roll Drift=±0.0183° per 5 minutes of heavy movement.

### Translating IMU data to VR

In the LiGHT-VR project, a goal of the project was to create a glove that could provide very accurate control in VR situations which surpassed typical machine vision in ability and elegance compared to regular controllers. The core aspect of making this work involved transporting data from the glove into a VR game engine and ensuring that such data was compatible. Beyond simply connecting the glove and a VR program to send data properly, there is that requirement that the data of position or orientation be processed and translated so that the VR engine can use it correctly due to the difference in reality references compared to virtual reality. For this section, the main discussion involves exploring processes of combining and interpreting the quaternions sent from the BNO085 IMU and the quaternions that would be read from the machine vision located in a VR headset, all within the Unity game engine. By default, the machine vision quaternions (MV) are fed to orient and rotate fingers inside of the Unity program. Once the quaternions were matched and translated correctly, it would mean that the glove is now able to generate useful orientation information that can actually be translated into the VR environment rather than being its own standalone orientation measurement separate from the VR part.

### Determining a Confidence Rating

Before experimentation, it can be helpful to explain how the quaternions can be utilized in Unity for a better understanding of when and how each quaternion from the IMU or machine vision (MV) gets used or prioritized. One option is to utilize a confidence rating system where each of the two quaternion readings are assigned a confidence rating. The higher the confidence rating of a quaternion reading, the more accurate it is to reality or to how the hand should truly be oriented. Subsequently, a confidence generating algorithm can be developed which could be based on several factors or conditions. For the IMU's quaternion confidence rating, it could be based on several factors such as the built-in accuracy rating found in each reading of the BNO085, how much time has occurred since last tare due to the quaternion drift found previously, how violently the IMU has been moving. For the MV's quaternion confidence rating, a desirable option to base that one off of would be applying conditional checks for how in-view the fingers are.

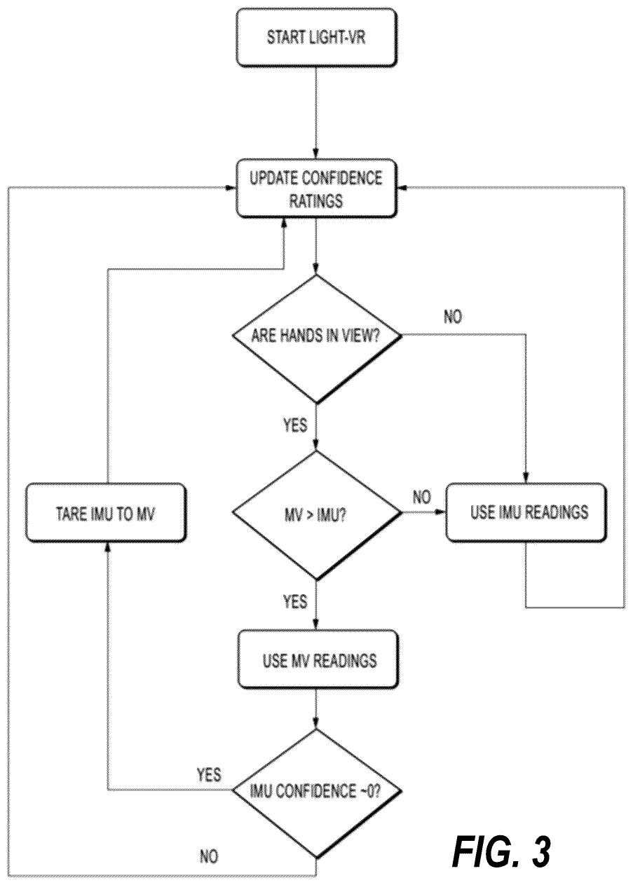

However, a much simpler and reduced version of this idea is to assign a fixed rating depending on where each hand is located, as shown in FIG. 3. Essentially, when the hand is not in view of the machine vision to generate those quaternions, the IMU readings simply take over since they are independent of the MV quaternion. Then, anytime a finger is directly visible to the headset's cameras, the system could simply remain using those MV quaternions from the camera. Although this has the downside of being more inaccurate compared to reality, at its core, what can be most desirable is where the user perceives their hands within the virtual reality setting only which is inherently true of the MV quaternion. This is because from the user's perspective, they will only ever interact with the VR environment and would not be able to directly compare where their hands are in reality which reduces the importance of true perfect accuracy. For this reason, the MV quaternions may have the most priority unless it simply cannot be read. The benefit here is that the overall quaternion decision system is much simpler and the VR environment can still take advantage of the glove because the fingers will not always be visible to the VR headsets cameras.

Nevertheless, in either quaternion system method, what can also be important is to establish that both the IMU and MV quaternions are compatible in the first place. By default, both readings utilize difference reference points or origins that change their readings relative to each other. The result of this is that when directly comparing the quaternions, they provide different values of each quaternion component, even if they are supposed to represent the same exact orientation of something such as the finger. Thus, a desirable step can be to manipulate or transform either one to match to other so that both would be based off the same or similar origins and remove the discrepancy in their components.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A haptic sensing device comprising:
one or more finger caps, each configured to secure one or more finger sensors to a distal tip of a finger proximate a fingernail of a user; and
a controller in communication with one or more of the finger sensors;
wherein:
the controller is configured to receive sensor data signals from one or more of the finger sensors and, based at least in part on the received sensor data signals, track a movement of respective fingers of the user in an extended reality environment; and
each finger cap comprises an opening configured to expose at least a portion of a finger pad of a respective finger therethrough.

2. The haptic sensing device of claim 1, wherein:
each of the finger sensors comprise at least one inertial measurement unit (IMU); and
the sensor data signals comprise IMU data.

3. The haptic sensing device of claim 2, wherein the IMUs comprise an accelerometer, a magnetometer, and a gyroscope.

4. The haptic sensing device of claim 2, wherein:
the controller is further configured to receive visual data and determine whether the visual data is indicative of a visual representation of a predetermined portion of respective fingers of the user;
the controller is further configured such that if the controller determines the visual data is indicative of the visual representation of the predetermined portion of the respective fingers of the user, the controller tracks the movement of the respective fingers of the user in the extended reality environment based, at least in part, on the visual data.

5. The haptic sensing device of claim 4, wherein the controller is further configured such that if the controller determines the visual data is not indicative of the visual representation of the predetermined portion of the respective fingers of the user, the controller tracks the movement of the respective fingers of the user in the extended reality environment based, at least in part, on the IMU data.

6. The haptic sensing device of claim 2, wherein each of the finger caps are configured to exert a compressive force on the corresponding distal tip of the respective finger.

7. The haptic sensing device of claim 6, wherein each finger cap further comprises an elastomer material.

8. (canceled)

9. The haptic sensing device of claim 1, wherein the controller comprises a wrist portion configured to be removably attached to the user proximate the user's wrist.

10. The haptic sensing device of claim 1, wherein each of the finger sensors is electrically coupled to at least a portion of the controller via one or more wires having a length ranging from eight to 14 inches.

11. The haptic sensing device of claim 1, wherein each of the finger sensors comprise a haptic feedback actuator configured to provide physical haptic feedback to the fingertips of the user.

12. The haptic sensing device of claim 11, wherein the haptic feedback actuator is selected from the group consisting of a vibration motor, a hydraulically amplifies self-healing electrostatic (HAZEL) actuator, an electroosmotic pump array, a piezoelectric actuator, and a microhydraulic actuator.

13. A method of tracking hand movement of a user in an extended reality environment, the method comprising:
receiving sensor data signals from one or more finger sensors, each finger sensor secured on a distal tip of a finger proximate a fingernail of the user via a finger cap comprising an opening configured to expose at least a portion of a finger pad of the corresponding finger therethrough;
receiving visual data;
determining whether the visual data is indicative of an image of a predetermined portion of the user's fingers; and
tracking a movement of the fingers of the user in an extended reality environment; wherein:
if the visual data is indicative of the image of the predetermined portion of the user's fingers, the tracking is based at least in part on the visual data or
if the visual data is not indicative of the image of the predetermined portion of the user's fingers, the tracking is based at least in part on the sensor data signals.

14. The method of claim 13, wherein:
each of the finger sensors comprise at least one inertial measurement unit (IMU); and wherein
the sensor data signals comprise IMU data.

15. The method of claim 13, wherein each of the finger caps is configured to exert a compressive force on the corresponding distal tip of the respective finger.

16. (canceled)

17. The method of claim 13, wherein:
each of the finger sensors comprise a haptic feedback actuator; and
the method further comprises providing, with the haptic feedback actuators, physical haptic feedback to the respective fingers of the user.

18. The method of claim 17, wherein the haptic feedback actuator is selected from the group consisting of a vibration motor, a hydraulically amplifies self-healing electrostatic (HAZEL) actuator, an electroosmotic pump array, a piezoelectric actuator, and a microhydraulic actuator.

19. A haptic sensing device comprising:
a plurality of finger sensors, each finger sensor comprising an inertial measurement unit (IMU); and
a controller in communication with the plurality of finger sensors and configured to;
receive sensor data signals comprising IMU data from the plurality of finger sensors and visual data; and
determine whether the visual data is indicative of an image of a predetermined portion of a user's fingers;
wherein:
if the visual data is indicative of the image of the predetermined portion of the user's fingers, the controller is further configured to track, based at least in part on the visual data, a movement of respective fingers of the user in an extended reality environment;
if the visual data is not indicative of the image of the predetermined portion of the user's fingers, the controller is further configured to track, based at least in part on the sensor data signals, a movement of respective fingers of the user in the extended reality environment;
each of the plurality of finger sensors is disposed on a respective finger cap comprising an elastomer material;
the finger caps are configured to secure the respective finger sensor to a distal tip of the respective finger proximate a respective fingernail of the user;
the finger caps are configured to exert a compressive force on the corresponding distal tip of the respective finger; and
each finger cap further comprises an opening configured to expose at least a portion of a finger pad of the corresponding finger therethrough.

20. (canceled)
